(19) United States
(12) Patent Application Publication
(10) Pub. No.: US 2005/0080654 A1
(43) Pub. Date: Apr. 14, 2005

(54) Integrated technology quality model

(76) Inventors: C.H.H. Huang, New York, NY (US); Anju Tandon, New Delhi (IN); Akhita Jha, New Delhi (IN); Anurag Dahiya, New Delhi (IN); Gauri Chandra, New Delhi (IN); Sonali Gulati, New Delhi (IN)

Correspondence Address: Charles Rattner, Apt. 7, 240 Wardwell St, Stamford, CT, 06902-5254, US

(21) Appl. No.: 10/682,705

(22) Filed: Oct. 8, 2003

(51) Int. Cl. G06F 17/60

(52) U.S. Cl. 705/7

(57) ABSTRACT

An integrated technology quality framework provides a decision-making matrix for managing and combining technology initiatives within a corporate environment. Related requests are grouped and available technology solutions are assessed. The technology requests are approved only when a solution is determined that aligns with the technology strategy and provides certain benefits such as an internal rate of return of a predetermined threshold value.

### FIELD OF THE INVENTION

This invention generally relates to business practices, and in particular it relates to decision-making processes involving technology requests.

### BACKGROUND OF THE INVENTION

Corporate software initiatives are increasingly important for establishing the efficient operation of corporate departments and standardizing operations among various corporate departments. Typically though, new software is developed or purchased each time there is a request for implementing a technology solution from corporate personnel. This has led corporations to purchase or implement many redundant or incompatible systems with similar functionalities across various internal departments, and sometimes within the same department. This unsophisticated approach for responding to technology requests generally results in undue expenditures for maintaining or accommodating the various systems implemented. Such costs will only increase over time for companies that respond to technology requests in this manner.

The development of a standard procedure for analyzing and responding to technology implementation requests, on the other hand, can reduce unnecessary expenditures and enable clear technology-enabled business growth. The resulting savings can then be passed on to corporate customers, giving a corporation a potential market advantage. Accordingly, there is a need for an integrated technology model for responding to technology implementation requests, which addresses certain problems of existing practices.

### SUMMARY OF THE INVENTION

It is an object of the present disclosure, therefore, to introduce methods for responding to technology implementation requests, in which they are first examined to determine whether they correspond to an existing corporate technology strategy, such as software defect reduction, technology investment optimization and technology integration initiatives. If so, various technology solutions (for example, “off-the-shelf”software applications) available for the technology implementation request are identified. Benefits of each solution are clearly evaluated with respect to various factors, such as internal rate of return, financial exposure reduction, reduction or elimination of company risks or liabilities and the like. For example, an internal rate of return for each of the available technology solutions is calculated and when the rate of return is at least equal to a predetermined value, that technology solution is accepted and implemented. Where there are various qualifying technology solutions, the technology solution having the highest rate of return may be selected, particularly where one or more other benefits are also applicable.

If, on the other hand, the technology implementation requests do not correspond to an existing technology strategy, they are then examined to determine whether they involve an automation of a business process, a compliance function, an auditing function, and/or a decommission of a current technology solution. If so, technology solutions available for the technology implementation request are identified and accepted as above.

The technology implementation requests may also be examined to determine whether they correspond to a business process that requires streamlining, and if so, a redesign of that business process is initiated.

Cost savings from responding to various technology implementation requests in this manner may be tracked, and may be passed on to consumers and the like.

In certain embodiments, any or all of the processes above may be automated by a system with appropriate solutioning.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a flowchart depicting an exemplary decision-making process for evaluating internal technology requests.

### DETAILED DESCRIPTION OF THE SPECIFIC EMBODIMENTS

The Integrated Technology Quality Model (ITQM) disclosed herein is a framework that introduces a discipline for responding to technology implementation requests, and by which various requests can be integrated. By implementing this framework, corporations are better able to manage their technology portfolio and supporting architecture end-to-end, leading to cost reductions, reduced system redundancy, increased operation efficiency, and optimization of investment in technology. ITQM also provides a method for evaluating the health of existing technology solutions within a corporate department, or among various departments, by which the technology portfolio of a company may be examined for optimization.

ITQM is based on the following guiding principles:
(1) Refining or streamlining a technology portfolio by enhancing core systems and decommissioning redundant or non-core systems,
(2) Optimizing the technology portfolio by implementing technology-related initiatives to re-engineer internal business processes and/or the infrastructure that supports such processes; and
(3) Transforming the technology portfolio by implementing component-based solutions where possible in order standardize and centralize business processes.

Additionally, the following rationales for responding to technology implementation requests are introduced:
(1) There should be no need to create or purchase new software applications if existing applications can be enhanced or componentized to address the request, whereby clear “build” versus “buy” decisions can be made with respect to a request; and
(2) Component-based architecture, that is adaptive in nature, should be developed for each business process or department, whereby the business process architecture and specialized business processes can be developed into general or centralized components.

ITQM thus serves as a universal guideline for managing and optimizing a corporate technology portfolio end-to-end, especially when one or more corporate technology strategies exist and each request is aligned with one or more of the strategies. Such corporate technology strategies may include plans for: software defect reduction, technology investment optimization, and technology integration.

Secondary corporate strategies, such as those of a department within a corporation or of an individual company within a conglomeration, may also be considered within the ITQM framework. Such secondary strategies may include: technology consumption management, thinning technology portfolios, or implementing more adaptive and flexible architecture.

By grouping various technology implementation requests based on the strategies with which they are aligned, several requests may be fulfilled simultaneously rather than managing and addressing each request individually. The benefits of this grouping of requests include costs savings and operating efficiencies. Thus, ITQM allows corporations to integrate various requests to ensure that the benefits of implementation are maximized.

ITQM also allows a corporation to understand the health of its existing applications so that informed decisions can be more readily made about whether to refine, optimize, or transform the technology portfolio in response to a request. For example, ITQM will allow a corporation to identify those existing applications in use which are low-value, inefficient and too expensive to maintain, those which are performing well but contribute little value or efficiency, and those which are strategic but should be transformed.

By implementing ITQM principles, corporations may achieve reduced redundancy in its technology portfolio, standardization of software architecture, optimization of technology infrastructure, and reduction in the number of non-standard software applications (such as specialized or proprietary databases) in use.

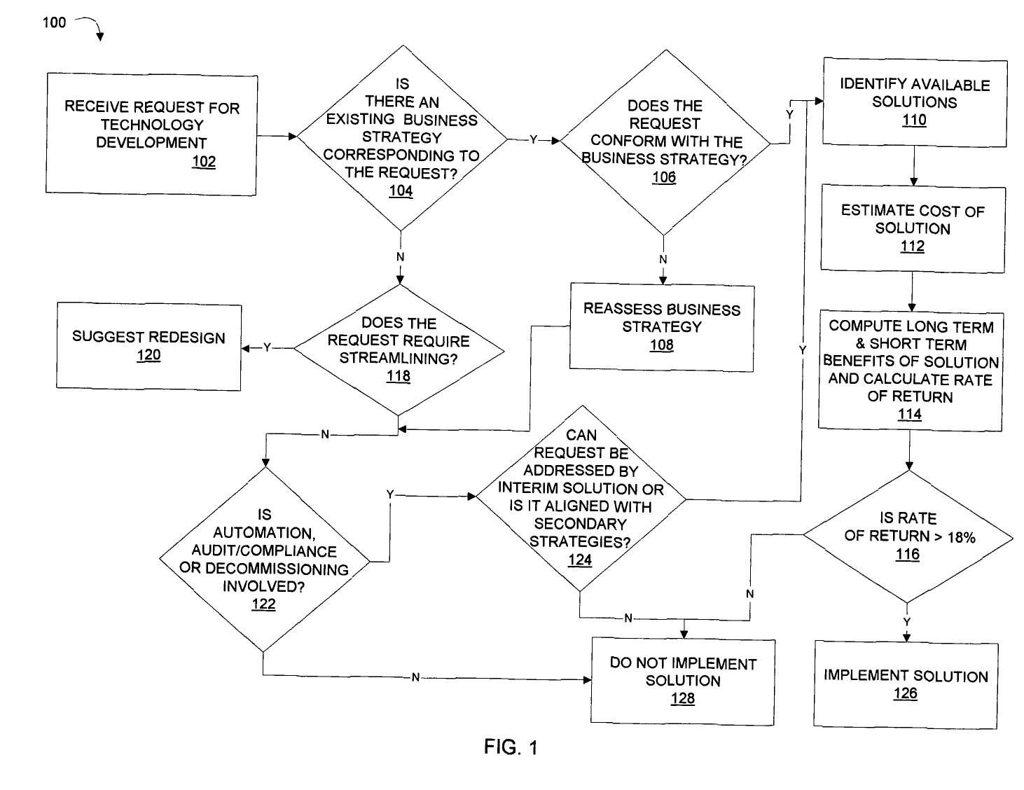

Referring now to FIG. 1, wherein similar components of the present disclosure are referenced in like manner, a particular embodiment of a process 100 for responding to technology implementation requests is disclosed.

It should be readily appreciated that none, some or all of the steps described below may be performed in any order, or certain steps may be omitted depending on the circumstances of a particular request. The steps described below may also be automatically performed by a computing device having appropriate programming, such as by implementing the steps as a series of algorithms in a programming language (i.e., C++, JAVA or any other appropriate software platform) that are executed by a personal computer, a network server, a group of such computing devices, or the like. Such computing device(s) may access various databases holding appropriate data for calculating the required algorithmic results. It should also be readily apparent that a wide variety of software applications may be employed to accomplish this, and so particular programming and applications will not be described in detail.

According to the process 100, at the start of an ITQM assessment a request for technology implementation is received, for example, from corporate personnel (step 102). The technology implementation request may include any request, such as to purchase or develop a software application to handle a corporate business process. The business process may be any known corporate process such as tracking payroll, accounts payable, accounts receivable, managing inventory, tracking product shipments, or any of a variety of typical corporate functions.

Next, the request is examined to determine whether the request corresponds to any existing business strategy (step 104), such as the business strategies described in the foregoing. For example, the technology implementation request may be a request to reduce the number of bugs in an accounting application and it may be determined that this request corresponds to a corporate technology strategy of reducing software defects in existing applications. If the request is indeed in conformance with a technology strategy, the process 100 continues to step 106 immediately below. Otherwise, the process 100 continues to step 118, described later below.

At step 106, it is determined whether the request is in conformance with the business strategy. In the example given in the immediately-preceding paragraph, the request may actually be to replace the software with another application, and so this type of request may not conform to the business strategy of reducing software defects within an existing application. Where the request is not in conformance with any business strategy, the process 100 continues to step 108 immediately below. Otherwise the process 100 continues to step 110, described later below.

From step 106, when the request relates to, but is not in conformance with, an existing business strategy, the business strategy may be reassessed (step 108) to determine if it should be modified to allow the technology request, after which the process 100 continues to step 122 below.

From step 106, when the request instead relates to and is in conformance with a business strategy, various solutions may be identified for responding to the request (step 110). The solutions may include available, off-the-shelf software applications, development of a proprietary solution, and the like. Next, a cost of the solution is estimated (step 112) and benefits analyses for each possible technical solution. Benefits may include any one or more of an internal rate of return (IRR), an analysis of financial exposure reduction, and/or reduction or elimination of company risks for the solution. The benefits may be evaluated in any standard and well-known manner.

From step 112, the process 100 continues to step 114 where it is determined whether the IRR, and/or one or more of the other analyzed benefits, is greater than a predetermined threshold value. For example, a corporation may determine that no technical solution having an IRR that is less than 18% may be adopted. Other threshold values may readily be used and, based on the manner used for calculating the IRR, the desired value may have to exceed a predetermined value or be less than a predetermined value, as is appropriate to the particular system employed. In the example provided, if the IRR of the solution exceeds the predetermined value of 18%, the process continues to step 126 below. Otherwise, the process continues to step 128.

Returning to step 104 above, when the request does not correspond to a business strategy, it is next determined whether a business process corresponding to the technology acquisition request requires streamlining (step 118). That is, it is determined whether the request corresponds to enhancing a core technology system or decommissioning a non-core system. If the requests pertains to such streamlining, the process continues to step 120, immediately below. Otherwise, the process 100 continues to step 122, described later below.

At step 120, a redesign of the business process is initiated and the process 100 then ends with respect to the request.

At step 122, it is determined whether the request relates to an automation of an existing manual business process, or relates to an internal audit or compliance process, or relates to decommissioning of a core system. If so, the process 100 continues to step 124 immediately below. If not, the process 100 continues to step 128, described later below.

At step 124, it is determined whether the request can be addressed by a temporary or interim solution or whether it is aligned with a secondary technology, such as those described in the foregoing. If so, the process returns to steps 110-116 above. Otherwise, the process 100 continues to step 128 below.

At step 126, the solution may be accepted for the technology implementation request. In the case where there are multiple solutions having the requisite benefits, e.g., IRR, the solution having the highest IRR may be selected. After step 126, the process 100 ends with respect to the request.

At step 128, the solution is not implemented and the technology implementation request is denied, after which the process 100 ends with respect to the request.

It should be readily apparent that the process 100 may be continually performed with respect to a continuous or sporadic stream of corporate technology acquisition requests. The process 100 may also be equivalently performed for the technology portfolio as a whole, or to portions thereof, without a specific technology implementation request as described above. In this case, each application in a technology portfolio may be examined via the process 100 to determine the approach to be taken for optimizing the entire technology portfolio. The portfolio may also be examined with the goal of attaining a certain maturity level for software processes. The CAPABILITY MATURITY MODEL FOR SOFTWARE (CMM or SW-CMM) is one existing model developed by the SOFTWARE ENGINEERING INSTITUTE for judging the maturity level of a corporation with respect to existing software processes.

Using ITQM in any of the various embodiments described above, a corporation may streamline its technology portfolio by enhancing core systems, and decommissioning redundant/non-core ones, implement technology related initiatives to re-engineer processes and infrastructure, and/or implement component based solutions to enable various technology strategies for its business operations. ITQM thus has the potential to save large corporations hundreds of thousands to millions of dollars in annual expenditures and has the capability to enable business growth using appropriate technology strategies for business. Such savings may be tracked and reported in any standard manner, and resulting efficiencies may be passed on to consumers and the like.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims.

1. A method for responding to technology implementation requests, comprising:
receiving a technology implementation request;
determining that the technology implementation request corresponds to an existing technology strategy;
identifying a technology solution available for the technology implementation request;
calculating a rate of return for the technology solution; and
accepting the technology solution for the technology implementation request when the rate of return is at least equal to a predetermined value.

2. The method of claim 1, further comprising:
determining an estimated cost of the technology solution, wherein the rate of return is calculated based on the estimated cost.

3. The method of claim 1, further comprising:
rejecting the technology implementation request when the rate of return is less than a predetermined value.

4. The method of claim 1, the technology strategy comprising a plan for software defect reduction.

5. The method of claim 1, the technology strategy comprising a plan for technology investment optimization.

6. The method of claim 1, the technology strategy comprising a plan for technology integration.

7. The method of claim 1, said receiving the technology implementation request further comprising:
receiving a plurality of technology acquisition requests; and
combining similar technology acquisition requests into a single request.

8. The method of claim 1, said accepting the solution further comprising:
accepting the technology solution having a highest rate of return from a plurality of available technology solutions.

9. The method of claim 1, said accepting further comprising:
accepting a plurality of technology solutions for a plurality of technology implementation requests; and
calculating a realized technology implementation savings based on said accepting.

10. The method of claim 1, wherein the technology solution includes a component-based software application.

11. A method for responding to technology implementation requests, comprising:
receiving a technology implementation request;
determining that the technology implementation request does not correspond to an existing technology strategy;
determining that the technology implementation request includes at least one of an automation of a business process, a compliance function, an auditing function, and a decommission of a current technology solution; and
identifying a technology solution available for the technology implementation request.

12. The method of claim 11, further comprising:
adjusting the technology strategy when the technology implementation request does not correspond to an existing technology strategy.

13. The method of claim 11, further comprising:
determining an estimated cost of the technology solution, wherein the rate of return is calculated based on the estimated cost.

14. The method of claim 11, further comprising:
rejecting the technology implementation request when the rate of return is less than a predetermined value.

15. The method of claim 11, the technology strategy comprising at least one of software defect reduction, technology investment optimization and technology integration.

16. The method of claim 11, said receiving the technology implementation request further comprising:
receiving a plurality of technology acquisition requests; and
combining similar technology acquisition requests into a single request.

17. The method of claim 11, further comprising:
calculating a rate of return for the technology solution; and
accepting the technology solution for the technology implementation request when the rate of return is at least equal to a predetermined value.

18. The method of claim 17, said accepting the solution further comprising:
accepting the technology solution having a highest rate of return from a plurality of available technology solutions.

19. The method of claim 17, said accepting further comprising:
accepting a plurality of technology solutions for a plurality of technology implementation requests; and
calculating a realized technology implementation savings based on said accepting.

20. The method of claim 11, wherein the technology solution includes a component-based software application.

21. A method for responding to technology implementation requests, comprising:
receiving a technology implementation request;
determining that the technology implementation request does not correspond to an existing technology strategy;
determining that the technology implementation request does not include any of an automation of a business process, a compliance function, an auditing function, and a decommission of a current technology solution; and
rejecting the technology implementation request.

22. The method of claim 21, said rejecting further comprising:
rejecting the technology implementation request when the technology implementation request can not be addressed by an interim solution and does not correspond to a secondary technology strategy.

23. A method for responding to technology implementation requests, comprising:
receiving a technology implementation request;
determining that the technology implementation request does not correspond to an existing technology strategy;
determining that the technology implementation request corresponds to a business process that requires streamlining; and
initiating a redesign of the business process.

24. A method for responding to technology implementation requests, comprising:
receiving a technology acquisition request for a business process;
initiating a redesign of the business process when the business process requires streamlining; and
identifying a technology solution for the technology acquisition request when the technology acquisition request corresponds to at least one of an existing business strategy, an automation of the business process, a compliance function, an auditing function, and a decommission of a current technology solution.

25. The method of claim 24, further comprising:
calculating a rate of return for the technology solution; and
accepting the technology solution for the technology implementation request when the rate of return is at least equal to a predetermined value.

26. The method of claim 24, further comprising:
calculating a rate of return for the technology solution; and
rejecting the technology solution for the technology implementation request when the rate of return is less than a predetermined value.

27. A method for responding to technology implementation requests, comprising:
receiving a technology implementation request;
determining that the technology implementation request corresponds to an existing technology strategy,
identifying a plurality of technology solutions available for the technology implementation request;
analyzing at least one benefit of each of the technology solutions; and
accepting the technology solution having a greatest number of benefits for the technology implementation request.

28. The method of claim 27, the at least one benefit comprising at least one of
an internal rate of return, a reduction in financial exposure, and a reduction of corporate liability.
